(19) United States
(12) Patent Application Publication
(10) Pub. No.: US 2013/0127324 A1
(43) Pub. Date: May 23, 2013

(54) PLASMA TORCH WITH MULTIPLE INLETS FOR GUIDING COOLING GAS

(71) Applicant: AGILENT TECHNOLOGIES, INC, Loveland, CO (US)

(72) Inventors: Sean M. KENT, Hughesdale (AU); Hugh Charles STEVENSON, Hughesdale (AU); Benjamin J. PUGSLEY, Vermont South (AU); Lars NIELSEN, Mont Albert (AU)

(73) Assignee: AGILENT TECHNOLOGIES, INC, Loveland, CO (US)

(21) Appl. No.: 13/658,227

(22) Filed: Oct. 23, 2012

Related U.S. Application Data
(60) Provisional application No. 61/562,131, filed on Nov. 21, 2011.
(60) Provisional application No. 61/623,680, filed on Apr. 13, 2012.

(51) Int. Cl. H05H 1/28

(52) U.S. Cl. 313/36

(57) ABSTRACT

A plasma torch comprises: a glass inner tube comprising an outlet where a plasma is formed; a glass outer tube comprising at least three inlets for receiving a cooling gas and distributing the cooling gas between the glass outer tube and the glass inner tube; and a cartridge housing comprising a gas receiving inlet, the glass outer tube being in fluid communication with the gas receiving inlet. Any two of the at least three inlets are radially offset by fewer than 180°.

### CROSS-REFERENCE TO RELATED APPLICATION

The present application claims priority under 35 U.S.C. §119(e) to U.S. Provisional Application No. 61/562,131 entitled “Plasma Torch with Multiple Inlets for Guiding Cooling Gas” and filed on Nov. 22, 2011. The present application also claims priority under 35 U.S.C. §119(e) to U.S. Provisional Application No. 61/623,680 entitled “Plasma Torch with Multiple Inlets for Guiding Cooling Gas” and filed on Apr. 13, 2012. The entire disclosures of these cross-referenced U.S. Provisional Applications are incorporated herein by reference.

### BACKGROUND

Plasma torches are used for the generation and transmission of plasmas for use in a variety of applications in analytical chemistry. For example, inductively coupled plasma (ICP) is commonly used in such applications.

Cartridge-style plasma torches facilitate connection of the plasma source to the instrument that relies on the plasma for chemical analysis. Cartridge-style plasma torches are configured for automatic connections when disposed in a torch loader. By contrast certain types of plasma torches require separate tubing connections to be made for the torch to generate a plasma.

Certain portions of cartridge-style plasma torches comprise glass material. When a plasma ball is created in the torch, the extreme heat generated by the torch can adversely impact the quartz glass components, causing premature failure of the plasma torch.

There is a need therefore, for a plasma torch that overcomes at least the shortcoming of known plasma torches described above.

### SUMMARY

In a representative embodiment, a plasma torch comprises: a glass inner tube comprising an outlet where a plasma is formed; a glass outer tube comprising at least three inlets for receiving a cooling gas and distributing the cooling gas between the glass outer tube and the glass inner tube; and a cartridge housing comprising a gas receiving inlet, the glass outer tube being in fluid communication with the gas receiving inlet. Any two of the at least three inlets are radially offset by fewer than 180°.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 is a perspective view of a cartridge-style plasma torch in accordance with a representative embodiment.

FIG. 2 is a cross-sectional view of the plasma torch depicted in FIG. 1 taken along the line 2-2.

FIG. 3 is a simplified cross-sectional view of a plasma torch illustrating gas flow in accordance with a representative embodiment.

FIG. 4 is a top view of a plasma torch comprising three inlets in accordance with a representative embodiment.

### DETAILED DESCRIPTION

In the following detailed description, for purposes of explanation and not limitation, representative embodiments disclosing specific details are set forth in order to provide a thorough understanding of the present teachings. Descriptions of known devices, materials and manufacturing methods may be omitted so as to avoid obscuring the description of the example embodiments. Nonetheless, such devices, materials and methods that are within the purview of one of ordinary skill in the art may be used in accordance with the representative embodiments.

It is to be understood that certain terminology defined herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a”, “an” and “the” include both singular and plural referents, unless the context clearly dictates otherwise. Thus, for example, “a device” includes one device and plural devices.

As used in the specification and appended claims, and in addition to their ordinary meanings, the terms “substantial” or “substantially” mean to within acceptable limits or degree.

As used in the specification and the appended claims and in addition to its ordinary meaning, the term “approximately” means to within an acceptable limit or amount to one having ordinary skill in the art.

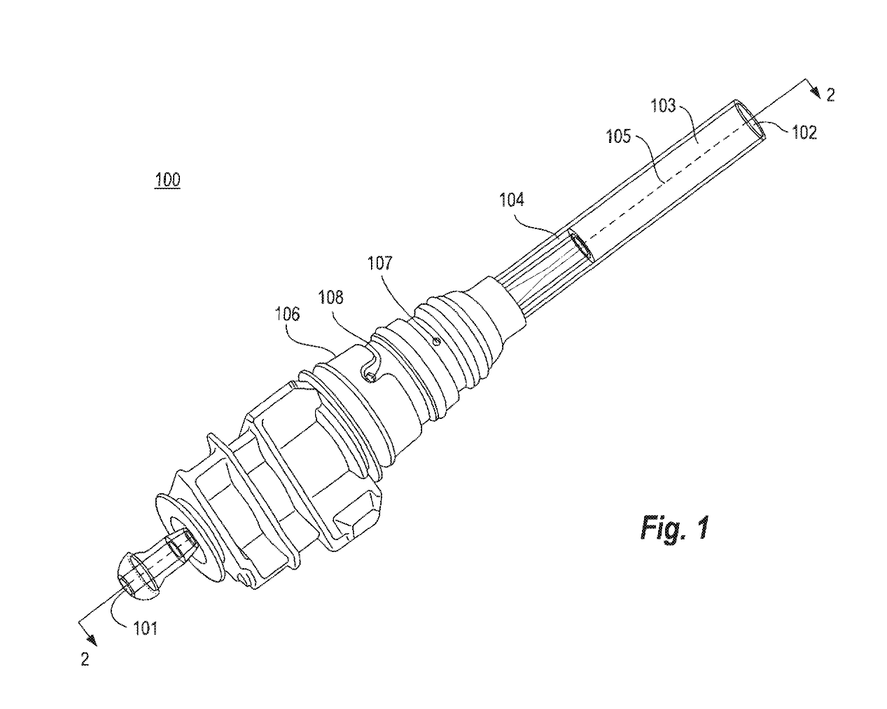

FIG. 1 is a perspective view of a plasma torch 100 in accordance with a representative embodiment. The plasma torch 100 comprises a first end 101 and a second end 102, with the first end 101 providing an inlet for aspirated sample injected into the plasma (not depicted in FIG. 1), and the second end 102 providing an outlet for the gas used to form the plasma. The plasma formed near the second end 102 of the plasma may be an inductively coupled plasma (ICP), or a microwave plasma (MP) formed using known devices (not shown), methods and materials.

A glass outer tube 103 is disposed about a glass inner tube 104, where the glass outer tube 103 and the glass inner tube 104 share a common axis 105 through the geometric centers thereof. A cartridge housing 106 contains certain portions of the plasma torch 100. The cartridge housing 106 is configured to connect to an analytical device (not shown). As described more fully below, the cartridge housing 106 comprises a first inlet 107 for providing a cooling gas between the glass inner tube 104 and the glass outer tube 103. The cooling gas provides a protective barrier between the glass outer tube 103 and the plasma. A second inlet 108 allows entry of gas into the plasma. In a representative embodiment, the cooling gas comprises nitrogen, although other gases suitable for providing a protective barrier between the glass outer tube 103 and the plasma are contemplated.

The glass inner tube 104 and the glass outer tube 103 may be one of a number of glass materials, such as a quartz glass material or other suitable ceramic materials. The cartridge housing 106 is generally fabricated from a known polymer material suitable for use in a cartridge-style plasma torch.

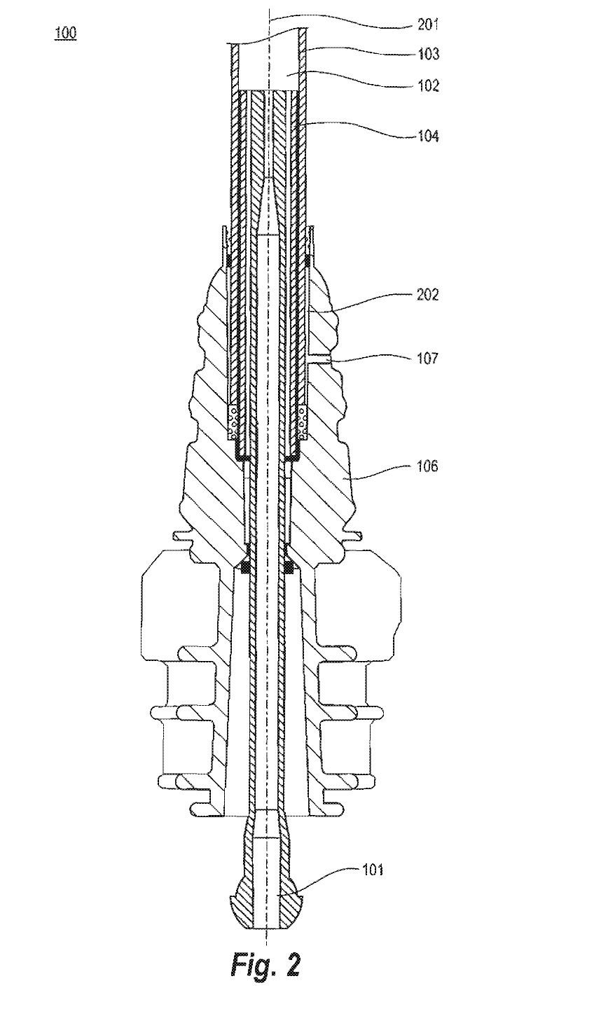

FIG. 2 is a cross-sectional view of the plasma torch 100 depicted in FIG. 1 taken along the line 2-2. As described above, the glass outer tube 103 is disposed concentrically around the glass inner tube 104, with the glass inner tube 104 and the glass outer tube 103 having a common axis 201 of symmetry through their respective geometric centers. As described more fully below, the first inlet 107 provides a cooling gas to plenum chamber 202, which evenly distributes the gas to a plurality of inlets (not shown in FIG. 2). The plurality of inlets fosters a more even distribution of the cooling gas between the glass inner tube 104 and the glass outer tube 103. The even distribution of the cooling gas mitigates the heat created by a plasma (not shown) formed at the second end 102 of the plasma torch 100, which ultimately substantially prevents the formation of “hot regions” around the glass outer tube 103, and increases the useful life of the plasma torch 100. The use of at least three inlets for providing cooling gas between the glass inner tube 104 and the glass outer tube 103 is especially useful to ensure a more even distribution of cooling gas, preventing “hot regions” from forming, preventing damage to the components (e.g., the glass inner tube 104 and the glass outer tube 103) of the plasma torch 100, and ultimately lengthening the useful life of the plasma torch 100.

In operation, gas useful in forming a plasma flows from the second inlet 108, with the aspirated sample entering at the first end 101 of the plasma torch 100 and exhausting out at the second end 102. Illustratively, the plasma is ICP or MP, formed by methods and materials which are known to one of ordinary skill in the art.

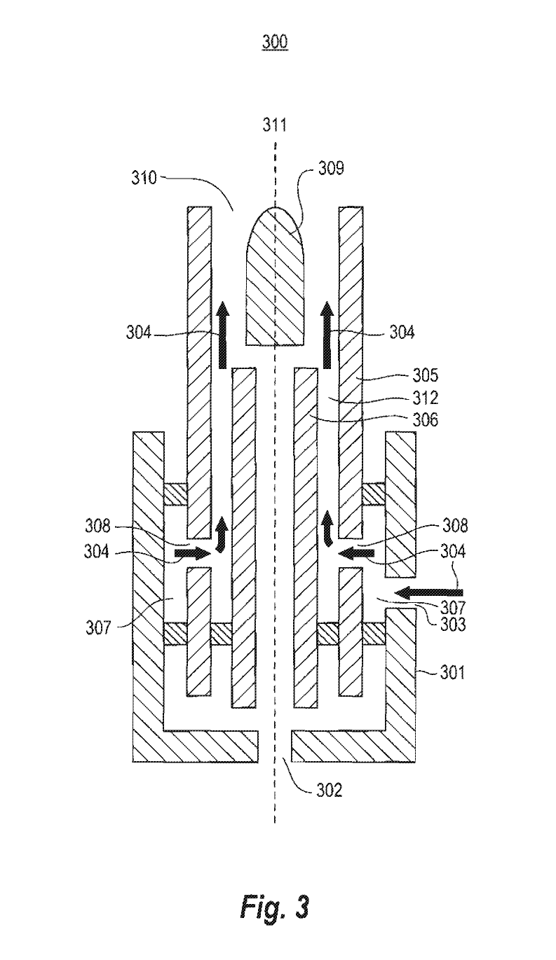

FIG. 3 is a simplified cross-sectional view of a plasma torch 300 illustrating gas flow in accordance with a representative embodiment. Many of the details of the plasma torch 100 described in connection with the embodiments depicted in FIGS. 1 and 2 are common to the plasma torch 300, and are not repeated.

Plasma torch 300 comprises a cartridge housing 301, having a first opening 302 and a second opening 303. The first opening 302 receives gas for generating a plasma from a gas source (not shown). The second opening 303 receives a cooling gas 304, which is illustratively nitrogen. The plasma torch comprises a glass outer tube 305 and a glass inner tube 306. A plenum 307 is formed between the glass outer tube 305 and the cartridge housing 301. The glass outer tube 305 comprises a plurality of inlets 308 that provide fluid path for the cooling gas 304 to travel from the second opening 303 through the plenum 307, then out through the gap 312, which functions as an outlet for the cooling gas.

A plasma 309 is formed at an outlet 310 of the glass inner tube 306. The plasma 309 is formed by a known method from the gas received at the first opening 302 of the plasma torch 300. As noted above, the plasma 309 is illustratively an ICP or an MP. The plasma 309 tends to expand, and can create unacceptable heating of the glass inner tube 306 and the glass outer tube 305. The heat created by the plasma 309 can compromise the integrity of the plasma torch 300 resulting in failure of the plasma torch 300, or a reduction in the useful life of the plasma torch 300, or both. The arrangement of the plurality of inlets 308 serves to provide the cooling gas 304 from the plenum 307. The cooling gas 304 flows continuously through the plurality of inlets 308, annularly around an axis of symmetry 311, and out through the gap 312, resulting in the dissipation of heat in and around the glass inner tube 306 and the glass outer tube 305.

In a representative embodiment, at least three inlets 308 are provided in the glass outer tube 305. Illustratively, the inlets 308 are provided at substantially equal angular intervals around the circumference of the glass outer tube 305. As such, if three inlets 308 are implemented, the inlets 308 are disposed at angular intervals of 120° around the circumference of the glass outer tube 305. Similarly, if four inlets 308 are implemented, the inlets 308 are disposed at angular intervals of 90°. While a practical limit on the number of inlets 308 is generally determined by experiment, the present teachings contemplate the use of 3, 4, 5, 6, 7, 8, 9 or 10 or more inlets 308. In addition, any two of the at least three inlets are radially offset by fewer than 180°.

By contrast, use of only one or two inlets 308 is insufficient to result in a suitable distribution of cooling gas 304 from the plenum 307 to effectively dissipate heat generated by the plasma 309.

It is emphasized that providing the inlets 308 at substantially equal angular intervals around the circumference of the glass outer tube 305 is merely illustrative, and the three or more inlets 308 may be provided at unequal angular intervals around the circumference of the glass outer tube 305.

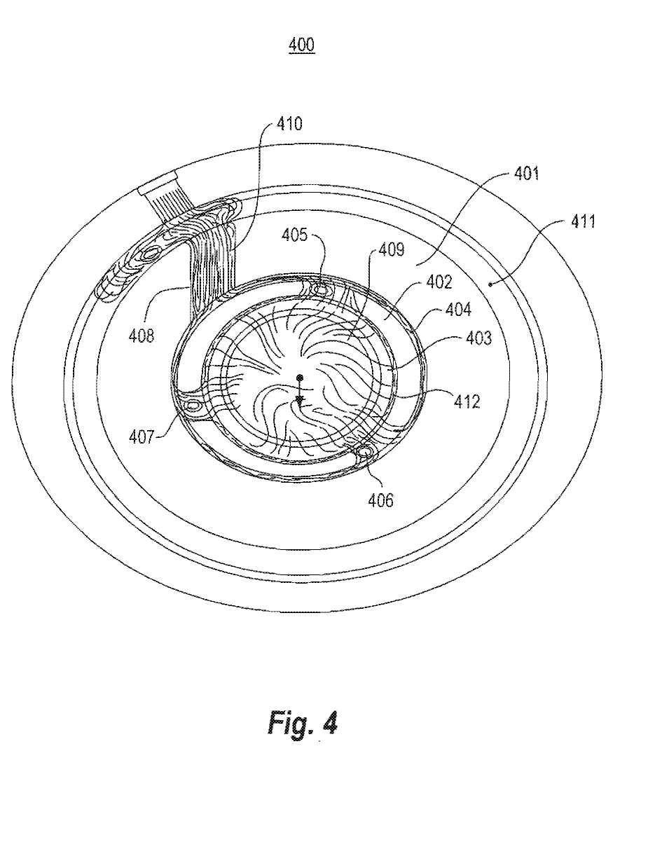

FIG. 4 is a top view of a plasma torch 400 illustrating gas flow in accordance with a representative embodiment. Many of the details of the plasma torch 100, 300 described in connection with the embodiments depicted in FIGS. 1-3 are common to the plasma torch 400, and are not repeated. The plasma torch 400 comprises a cartridge housing 401 with a glass outer tube 402 disposed concentrically around a glass inner tube 403. A plenum 404 is provided between the cartridge housing 401 and the glass outer tube 402. A first inlet 405, a second inlet 406 and a third inlet 407 are provided in the glass outer tube 402, and are in fluid communication with a cooling gas inlet 408 provided in the cartridge housing 401.

In the embodiment depicted in FIG. 4, the plasma torch 400 comprises three (3) inlets disposed at equal angular intervals of 120° around the circumference of the glass outer tube 402. As noted above a minimum of three inlets is required to provide sufficient distribution of cooling gas from the plenum 404 and around an annular gap 412 to effectively dissipate heat generated by a plasma 409 formed at an outlet of the glass inner tube 403. As further noted above, more than three inlets in the glass outer tube 402 for the delivery of cooling gas to the annular gap 412 are contemplated. Moreover, the equal angular spacing of the first, second and third (or more) inlets 405, 406 and 407 around the circumference of the glass outer tube 402 is merely illustrative and the first, second and third (or more) inlets 405, 406 and 407 may be disposed at unequal angular intervals around the circumference of the glass outer tube 402.

In operation, cooling gas 410 is provided from the cooling gas inlet 408 and travels from a space 411 that is annular around the cartridge housing 401. The cooling gas 410 traverses the space 411 through the plenum 404 and then flows through each of the first, second and third inlets 405, 406 and 407. The cooling gas 410 from the first, second and third inlets 405, 406 and 407 flows out of the annular gap 412 and dissipates heat generated by the plasma 409. The use of three or more inlets (e.g., first, second and third inlets 405, 406 and 407) fosters a better distribution of cooling gas 410 that flows out of the annular gap 412, and significantly improves the dissipation of heat from the plasma 409. As a result of the improved distribution of cooling gas 410 and the resultant distribution of heat from the plasma 409, protection of the glass outer tube 402 and the glass inner tube 403 from the heat of the plasma 409 is improved, resulting in reduced failure of the plasma torch 400, and longer useful life of the plasma torch.

In view of this disclosure it is noted that the various plasma torches and methods of use can be implemented in variant structures, using variant components and variant methods in keeping with the present teachings. Further, the various components, structures and parameters are included by way of illustration and example only and not in any limiting sense. In view of this disclosure, those skilled in the art can implement the present teachings in determining their own applications and needed components, materials, structures and equipment to implement these applications, while remaining within the scope of the appended claims.

1. A plasma torch, comprising:
a glass inner tube comprising an outlet where a plasma is formed;
a glass outer tube comprising at least three inlets for receiving a cooling gas and distributing the cooling gas between the glass outer tube and the glass inner tube; and
a cartridge housing comprising a gas receiving inlet, the glass outer tube being in fluid communication with the gas receiving inlet, wherein any two of the at least three inlets are radially offset by fewer than 180°.

2. A plasma torch as claimed in claim 1, wherein the glass outer tube is disposed concentrically around the glass inner tube.

3. A plasma torch as claimed in claim 2, wherein the cartridge housing is disposed concentrically around the glass outer tube.

4. A plasma torch as claimed in claim 1, wherein the glass inner tube and the glass outer tube each comprise a quartz glass material.

5. A plasma torch as claimed in claim 1, wherein the inlets for receiving the cooling gas are disposed at substantially equal intervals around a circumference of the glass outer tube.

6. A plasma torch as claimed in claim 1, wherein the inlets for receiving the cooling gas are disposed at intervals of 120° around the glass outer tube.

7. A plasma torch as claimed in claim 1, wherein the cooling gas is substantially evenly distributed around the glass inner tube.

8. A plasma torch as claimed in claim 1, wherein the cooling gas flows around a plenum between the cartridge housing and the glass outer tube.

9. A cartridge comprising the plasma torch of claim 1.
